(19) United States
(12) Patent Application Publication
(10) Pub. No.: US 2023/0113901 A1
(43) Pub. Date: Apr. 13, 2023

(54) SYSTEM AND METHOD FOR IDENTIFYING AND UTILIZING EFFECTIVENESS OF AN AGENT HANDLING ELEVATED CHANNELS DURING AN INTERACTION IN AN OMNICHANNEL SESSION HANDLING ENVIRONMENT

(71) Applicant: NICE LTD., Ra'anana (IL)

(72) Inventors: Kunal KHANVILKAR, Pune (IN); Mehul Patankar, Pune (IN); Rahul Vyas, Jodhpur (IN); Salil Dhawan, Pune (IN); Sourav Chauhan, New Delhi (IN)

(21) Appl. No.: 17/498,762

(22) Filed: Oct. 12, 2021

(51) Int. Cl. G06Q 10/06; H04L 12/58; H04M 3/22

(52) U.S. Cl. CPC G06Q 10/06398; H04L 51/10; H04M 3/2281; H04M 2203/401

(57) ABSTRACT

A computerized-method for identifying and utilizing effectiveness of an agent elevating channels during an interaction, in an Omnichannel-Session-Handling environment, is provided herein. The computerized-method may operate, during a duty-cycle, an Elevated Interaction Efficacy (EIE) module for each agent in a data-storage of agents. The EIE-module may include: (a) operating an interaction-module to retrieve one or more interactions of the agent; (b) filtering out from the retrieved interactions, one or more elevated interactions, based on one or more attributes from metadata of the retrieved interactions; (c) calculating an Elevated Interaction Handling (EIH) score for the agent based on one or more attributes from the metadata of the one or more elevated interactions; (d) storing the calculated EIH score in the data-storage of agents; and (e) sending the EIH score to one or more applications, to take one or more follow-up actions based on the EIH score and a calculated EIH threshold.

### TECHNICAL FIELD

The present disclosure relates to the field of data analysis for identifying and utilizing effectiveness of agent elevating channels during an interaction, at the same session, in an omnichannel session environment, to align it to applications, such as gaming solutions, quality management applications and other applications, for follow-up actions.

### BACKGROUND

In contact centers, omnichannel session handling allows agents to elevate channels during an interaction between an agent and a customer, when an issue may be better resolved over a different channel than the channel that is being used. For example, elevating a chat contact to a voice call when the text in the chat is not clear enough. In another example, when a quality of voice call is bad, the interaction may be continued via a chat channel. Such a channel type switch may be imperative in interactions which are not heading towards expected resolution in an efficient and effective manner.

An agent skill to handle such a sudden channel transition is important with reference to adhering to significant contact center Key Performance Indicator (KPI)'s and to providing better customer service and experience. Currently, there is no technical solution which enables contact centers to identify and then utilize an indication of effectiveness and efficiency of agent handling channels elevating during an interaction, at the same session.

Moreover, there is no technical solution which defines goals and metrices, e.g., a score, and utilizes this score as an indication of effectiveness of agent handling elevated channels during an interaction, at the same session, in processes of other applications, such as Quality Management (QM) application, a gamification module and an Automated Call Distribution (ACD) system.

Hence, there is a need for a technical solution that will derive an indication of agent's proficiency in handling an elevated interaction, at the same session.

### SUMMARY

There is thus provided, in accordance with some embodiments of the present disclosure, a computerized-method for identifying and utilizing effectiveness of an agent elevating channels during an interaction, in an Omnichannel Session Handling (OSH) environment.

Furthermore, in accordance with some embodiments of the present disclosure, in a computerized system comprising a processor, one or more applications, a data storage of interactions, a data storage of elevated interactions, and a data storage of agents and a memory to store the data storages, said processor is configured to operate, during a duty cycle, an Elevated Interaction Efficacy (EIE) module for each agent in the data storage of agents.

Furthermore, in accordance with some embodiments of the present disclosure, the operating of said EIE module may comprise: (a) operating an interaction module to retrieve one or more interactions of the agent from the data storage of interactions, according to a time range; (b) filtering out from the retrieved interactions, one or more elevated interactions, to be stored in the data storage of elevated interactions, based on one or more attributes from metadata of the retrieved interactions; (c) calculating an Elevated Interaction Handling (EIH) score for the agent based on one or more attributes from the metadata of the one or more elevated interactions to provide an indication as to an ability of the agent to elevate channels during an interaction at the same session; (d) storing the calculated EIH score in the data storage of agents; and (e) sending the EIH score to the one or more applications, to take one or more follow-up actions based on the EIH score and a calculated EIH threshold.

Furthermore, in accordance with some embodiments of the present disclosure, one application of the one or more applications may be a gamification application.

Furthermore, in accordance with some embodiments of the present disclosure, the one or more follow-up actions of the gamification application based on the EIH score, is providing at least one reward or recognition to the agent who participated in the one or more interactions that corresponds to the EIH score.

Furthermore, in accordance with some embodiments of the present disclosure, the at least one reward or recognition to the agent may be provided to the agent when the EIH score is above a predefined threshold or between a predefined range.

Furthermore, in accordance with some embodiments of the present disclosure, one application of the one or more applications may be a Quality Management (QM) application.

Furthermore, in accordance with some embodiments of the present disclosure, the one or more follow-up actions of the QM application based on the EIH score is assigning a coaching program by an evaluator. When the EIH score of one or more interactions may be below a predefined threshold, the agent who participated in the one or more interactions that corresponds to the EIH score may be assigned to a coaching program.

Furthermore, in accordance with some embodiments of the present disclosure, one application of the one or more applications is an Automated Call Distribution (ACD) system.

Furthermore, in accordance with some embodiments of the present disclosure, the one or more follow-up actions of the ACD system based on the EIH score includes changing attributes of routing skills of the agent.

Furthermore, in accordance with some embodiments of the present disclosure, the metadata of the one or more elevated interactions may include a customer sentiment score.

Furthermore, in accordance with some embodiments of the present disclosure, the calculating of the EIH Score (EIHS) may be based on formula I:

EIHS=CS*(1/T1+1/T2+. . . 1/Tn)*Weffective (1)

whereby: CS is a Customer Sentiment (CS) score for a given elevated interaction, Tn is time spent on channel-n, Weffective is an effective weighting factor of multiple channels request based on formula II: (II) Πᵢ₌₁^{N}Wi
whereby:
Wi equals T/D
whereby:
T is a total interaction volume occurred for a channel type in a previous duty cycle,
D is a duty cycle time range, which has been configured for EIE module to run.

Furthermore, in accordance with some embodiments of the present disclosure, the calculated EIH threshold may be corresponding to interaction characteristics to ensure consideration of interaction complexity.

Furthermore, in accordance with some embodiments of the present disclosure, interaction characteristics may be selected from at least one of: routing skills for an interaction, channel types involved in an elevated interaction.

Furthermore, in accordance with some embodiments of the present disclosure, the calculated EIH threshold is based on formula III:

$$EIH threshold = \frac{{\sum }_{i = 1}^{i = N} EIHSi}{N} \qquad ( III )$$

whereby:
EIHSi is an Elevated Interaction Handling Score for a give interaction, and
N is total interactions for a given one or more routing skills and channel type.

Furthermore, in accordance with some embodiments of the present disclosure, when the computerized-method may be operating in a cloud computing environment, before operating the EIE module, the computerized-method may be further comprising selecting a tenant from a data storage of tenants to operate the EIE module for each agent in the data storage of agents of the selected tenant.

Furthermore, in accordance with some embodiments of the present disclosure, the one or more attributes from metadata of the retrieved interactions are selected from at least one of: InteractionId, Interaction duration, customerRating, OpenReasonType and interactionStartTime. Customer rating is denoted as Customer Sentiment (CS) in the EIH score formula, and it may be given by the customer at any scale for the given interaction.

Furthermore, in accordance with some embodiments of the present disclosure, the filtering out from the retrieved interactions, one or more elevated interactions, to be stored in the data storage of elevated interactions, may be based on the OpenReasonType attribute.

There is further provided, in accordance with some embodiments of the present invention, a computerized-system for identifying and utilizing effectiveness of an agent elevating channels during an interaction, in an Omnichannel Session Handling (OSH) environment.

Furthermore, in accordance with some embodiments of the present disclosure, the computerized-system may include a processor, one or more applications; a data storage of interactions; a data storage of elevated interactions a data storage of agents; and a memory to store the data storages.

Furthermore, in accordance with some embodiments of the present disclosure, the processor may be operating a Multiple Multi-Channel Effectiveness (EIE) module for each agent in a data storage of agents. The EIE module may be configured to: (a) operate an interaction module to retrieve one or more interactions of an agent from the data storage of interactions, according to a time range; (b) filter out from the retrieved interactions, one or more elevated interactions, to be stored in the data storage of elevated interactions, based on one or more attributes from metadata of the retrieved interactions; (c) calculate an Elevated Interaction Handling (EIH) score for the agent based on one or more attributes from the metadata of the one or more elevated interactions to provide an indication as to an ability of the agent to elevate channels during an interaction at the same session; (d) store the calculated EIH score in the data storage of agents; and (e) send the EIH score to the one or more applications, to take one or more follow-up actions based on the EIH score and a calculated EIH threshold.

### BRIEF DESCRIPTION OF THE DRAWINGS

FIGS. 1A-1B schematically illustrates a high-level diagram of a computerized-system for identifying and utilizing effectiveness of an agent elevating channels during an interaction, in an Omnichannel Session Handling (OSH) environment, in accordance with some embodiments of the present disclosure;

FIGS. 2A-2B are a high-level workflow of Elevated Interaction Efficacy (EIE) module, in accordance with some embodiments of the present disclosure;

FIG. 3A is illustrating an example of calculating an Elevated Interaction Handling (EIH) threshold based on historical interactions data, in accordance with some embodiments of the present disclosure;

FIG. 3B is illustrating an example of filtering upcoming interactions for other applications, based on EIH threshold, in accordance with some embodiments of the present disclosure;

FIG. 4 is a high-level workflow of calculating an EIH score for agents of one or more tenants in a cloud computing environment, in accordance with some embodiments of the present disclosure;

FIG. 5 schematically illustrates components of an example of a computerized system for identifying and utilizing effectiveness of an agent elevating channels during an interaction, in accordance with some embodiments of the present disclosure; and

FIG. 6 is illustrating an example of a playback of elevated interaction between an agent and a customer in three different channels, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The phrase “elevated interactions”, as used herein, refers to a transition of an interaction between an agent and a customer, having no gap in time, from one channel type to another channel type, where the agent and the customer remain the same, in an Omnichannel Session Handling (OSH) environment.

The term “Omnichannel Session Handling (OSH) environment”, as used herein, refers to an environment enabling customer service via a plurality of channel types, such as email, Short Message Service (SMS), chat messaging and push notifications or any other type of channel.

The term “duty cycle”, as used herein, refers to a predefined duration of a module or an application.

The term “gamification”, as used herein, refers to a process of adding games or gamelike elements to a non-gamified environment, such as contact center environment. Gamification solutions may be used to engage employees and to improve performance.

The terms “customer sentiment” and “customer rating” are interchangeable.

Current researches show that companies who provide an omnichannel customer experience, via their contact centers, achieve a 91% higher year-over-year increase in customer retention, compared to organizations who don't provide an omnichannel customer experience. Also, contact centers without omni-channel capabilities are twice as likely to incur increases in customer service costs.

Today's consumers expect to connect with a service provider of a product in every possible way. Therefore, having customer service, as seamless as possible, through all types of channels, e.g., email, Short Message Service (SMS), chat messaging and push notification, ensures customer satisfaction. Operating an elevated interaction, i.e., switching channels during an interaction at the same session, in an omnichannel session handling environment, may bring a competitive advantage and many benefits for a business, such as providing a better customer experience and increasing customer-agent conversions volume in the contact center.

Currently, contact centers provide customer service via multiple channel types, such as email, Short Message Service (SMS), chat messaging, push notifications. When an agent can address customer issues and concerns quickly, on the channel type of the customer's choice, it may result with a better customers experience and hence, satisfied customers. This may substantially increase contact center performance by improving agent productivity and utilization, as agents can serve customers effectively and efficiently.

In some interactions between an agent and a customer, an issue may be better resolved over a different channel than the channel that is being used. For example, elevating an interaction from a chat channel to a voice call channel, when the text in the chat is not understood or not clear enough. In another example, when the quality of a voice call is bad, the interaction may be continued via a chat channel.

Current solutions of contact center systems don't have a technical solution which can identify and then utilize an indication of effectiveness and efficiency of an agent elevating an interaction at the same session. Furthermore, there is no technical solution that utilizes the identified effectiveness in other applications to take a follow-up action. Therefore, there is a need for a technical solution that will derive an indication of agent's proficiency in handling elevated interaction, at the same session.

Moreover, there is a need for a technical solution that will result in driving an overall evaluation and performance improvement process and lead to efficient contact centers, improved agents' productivity and utilization rates and satisfied customers, which may be reflected by an improved Net Promoter Score (NPS). The NPS is a measurement of customer experience and prediction of business growth.

Therefore, there is a need for a system and method for identifying and utilizing effectiveness of an agent elevating channels during an interaction, at the same session, in an Omnichannel Session Handling (OSH) environment, to derive an Elevated Interaction Handling (EIH) score for each agent, which may indicate the level of efficiency and effectivity of the agent, when the agent elevates channels during an interaction, at the same session, to be used in one or more applications for one or more follow-up actions.

According to some embodiments of the disclosure, the needed score of an elevated interaction handling, which measures the ability of an agent to switch an interaction from one channel type to another type, during an interaction, in the same session, i.e., same customer, same agent, may be used to better serve the customers issues or to bring to a prompt resolution.

According to some embodiments of the disclosure, an EIH score may be an indication that an agent is more efficient in handling cost per utilized channel, so this may improve the efficiency of the contact center. An ‘Elevated Interaction Handling threshold’ may be calculated against interaction characteristics, such as routing skills for an interaction and corresponding channel type.

According to some embodiments of the disclosure, an agent who is efficient in handling such elevated interactions, i.e., an agent having an EIH score above the calculated EIH threshold, may be a key person in the organization, that should be rewarded via an application, such as a gamification module.

According to some embodiments of the disclosure, an agent who is less efficient in handling such elevated interactions, i.e., an agent having an EIH score below the calculated EIH threshold, may be assigned to a training program by a Quality Management application.

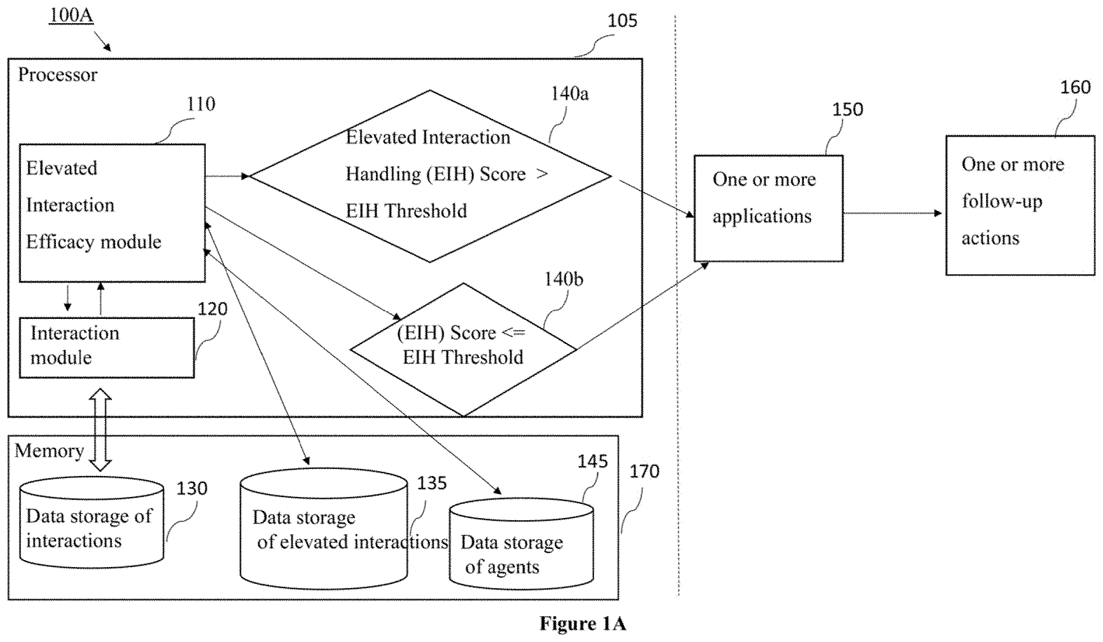

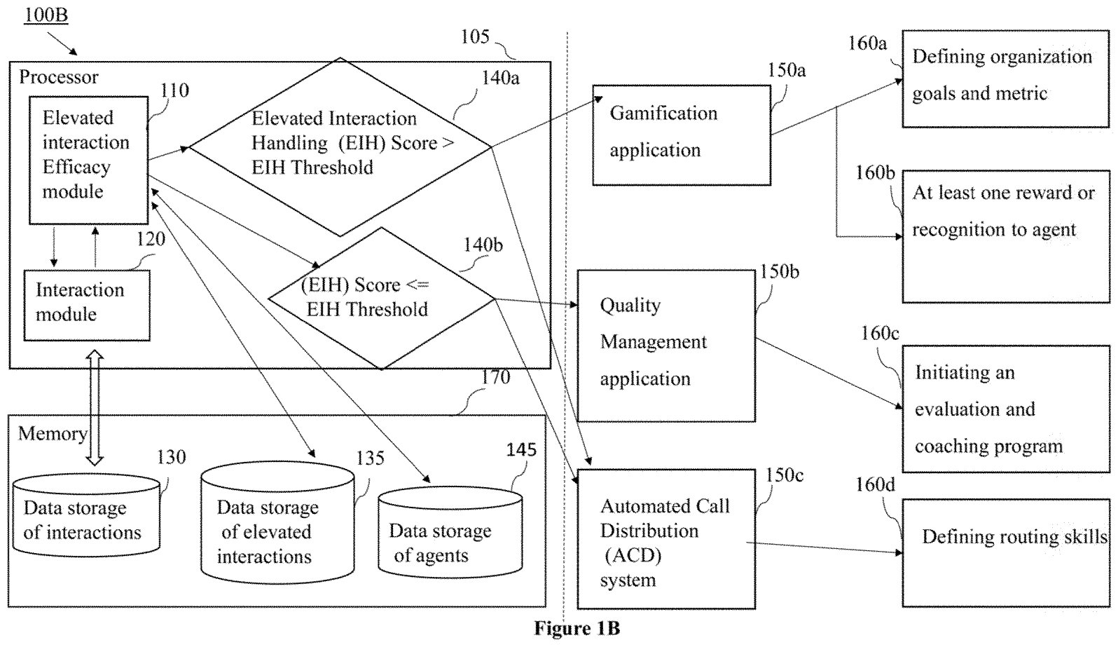

FIG. 1A schematically illustrates a high-level diagram of a computerized-system 100A for identifying and utilizing effectiveness of an agent elevating channels during an interaction, in an Omnichannel Session Handling (OSH) environment, in accordance with some embodiments of the present disclosure.

According to some embodiments of the present disclosure, in a computerized system, such as computerized system 100A, which may include a processor 105, one or more applications, such as one or more applications 150, a data storage, such as data storage of interactions 130, a data storage of elevated interactions 135 and a data storage of agents 145, and a memory 170 to store the data storages, the processor, such as processor 105 may be operating a module, such as Elevated Interaction Efficacy (EIE) module 110, for each agent in the data storage of agents 145.

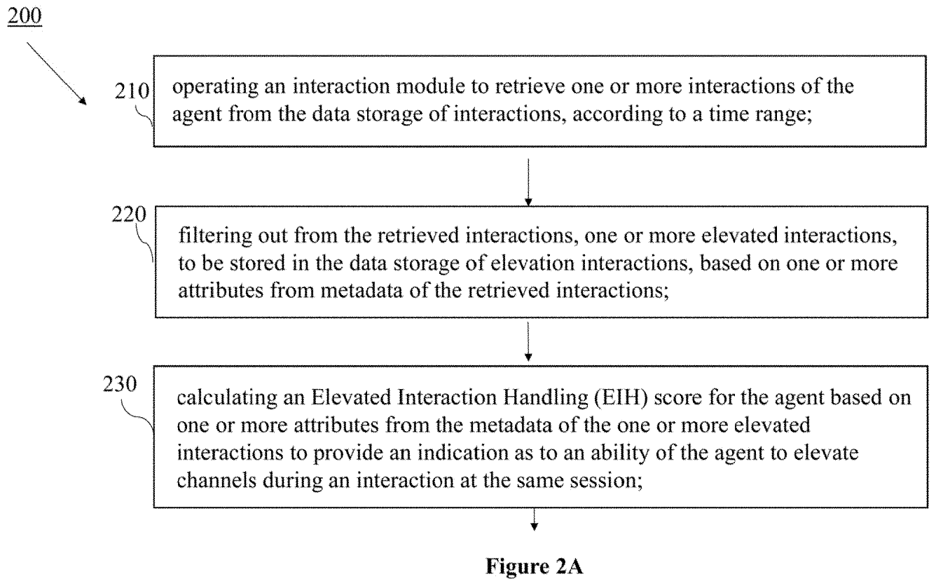

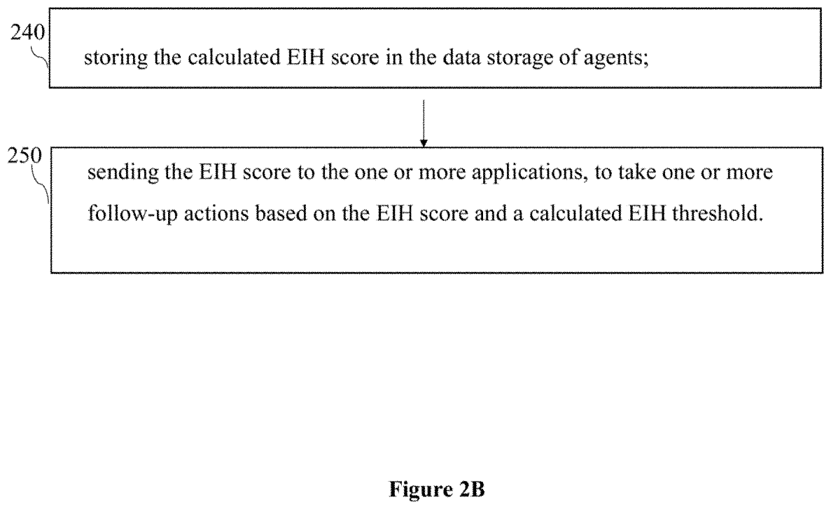

According to some embodiments of the present disclosure, a module such as EIE module 110A and such as EIE 200 in FIGS. 2A-2B, may operate for each agent in the data storage of agents 145, a module such as interaction module 120 to retrieve one or more interactions of an agent from the data storage of interactions 130, according to a time range.

According to some embodiments of the present disclosure, the EIE module 110 may further filter out from the retrieved interactions, one or more elevated interactions, to be stored in a data storage, such as the data storage of elevated interactions 135, based on one or more attributes from metadata of the retrieved interactions. Information related to the filtered interactions may be collected from various data sources and stored in a data storage, such as data storage of elevated interactions 135, which may be further utilized by EIE module 110.

According to some embodiments of the present disclosure, the collected information related to the filtered interactions may include one or more attributes from metadata thereof.

According to some embodiments of the present disclosure, the attributes of each interaction may be an InteractionId, which is an identifier of the interaction, Interaction duration, which is the length of the interaction session, customerRating, which is a rate provided by the customer engaged in the interaction after the end of the interaction, OpenReasonType which is an attribute of the interaction indicating the type of interaction whether the interaction is elevated or not and interactionStartTime which is an attribute that indicates the start time of the interaction between the customer and the agent. Customer rating is denoted as Customer Sentiment (CS) in the EIH score formula, and it may be given by the customer at any scale for the given interaction.

According to some embodiments of the present disclosure, the filtering out from the retrieved interactions of one or more elevated interactions, to be stored in the data storage of elevated interactions 135 may be based on the OpenReasonType attribute which indicates if the interaction has been elevated from one channel type to another one. In a non-limiting example, the OpenReasonType attribute may be retrieved from a JavaScript Object Notation (JSON) file format.

According to some embodiments of the present disclosure, the module, such as EIE module 110A and such as EIE module 200 in FIGS. 2A-2B, may calculate an Elevated Interaction Handling (EIH) score for each agent, based on one or more attributes from the metadata of the one or more elevated interactions, in the time range, to provide an indication as to an ability of the agent to elevate channels during an interaction, at the same session. A high EIH score, i.e., a score above the calculated threshold, may be an indication as to an ability or a high proficiency of the agent to elevate channels during an interaction, at the same session.

According to some embodiments of the present disclosure, the calculated EIH score may be stored in the data storage of agents 145. Furthermore, the calculated EIH score may be compared with a calculated EIH threshold 140a or 140b and may be sent to the one or more applications 150, to take one or more follow-up actions 160 based on the EIH score. When the EIH score is above the calculated EIH threshold it may indicate of agent's high proficiency of elevating interactions and the follow-up action may be a reward to the agent involved in the interaction. When the EIH score is below the calculated threshold, it may be an indication of poor performance of the agent in the aspect of elevating an interaction and the follow-up action may be training.

According to some embodiments of the present disclosure, the calculated EIH threshold may be corresponding to interaction characteristics to ensure consideration of interaction complexity. The EIH threshold may be calculated against each routing skill and its relevant area of issues, which is considered as the interaction complexity. Historical samples may be collected to calculate the EIH threshold.

According to some embodiments of the present disclosure, the calculating of the EIH Score (EIH) is based on formula I:

$$EIHS = CS * ( \frac{1}{T 1} + \frac{1}{T 2} + … \frac{1}{Tn} ) * Weffective \qquad ( I )$$

whereby:
CS is Customer Sentiment (CS) score for a given elevated interaction,
Tn is time spent on channel-n,
Weffective is an effective weighting factor of multiple channels request based on formula II:

Πᵢ₌₁^{N}Wi (II)

whereby:
Wi equals T/D
whereby:
T is a total interaction volume occurred for a channel type in a previous duty cycle,
D is a duty cycle time range, which has been configured for EIE module to run.

According to some embodiments of the present disclosure, an agent may have multiple EIH scores which may be categorized based on routing skills and problem area. Each EIH score may be for a different routing skill or the same routing skill. In case the agent has handled multiple elevated interactions for the same routing skill and the same area of issues then the EIH score may be calculated as the average of all related EIH scores during the duty cycle. The average EIH score of each category may be taken for further assessment via one or more applications 150, when an agent may have one or more EIH scores during the duty cycle.

According to some embodiments of the present disclosure, an average calculation for an agent having several EIH scores for the same category e.g., routing skill, may be based on formula IV: Agnetₙcategory₁=sum of all EIH score/number of total issues handled under the same category. Agnet1category1=sum of all EIHS score/total issue handled under same category

According to some embodiments of the present disclosure, the duty cycle time range may be configured for a module, such as the EIE module 110, e.g., three hours.

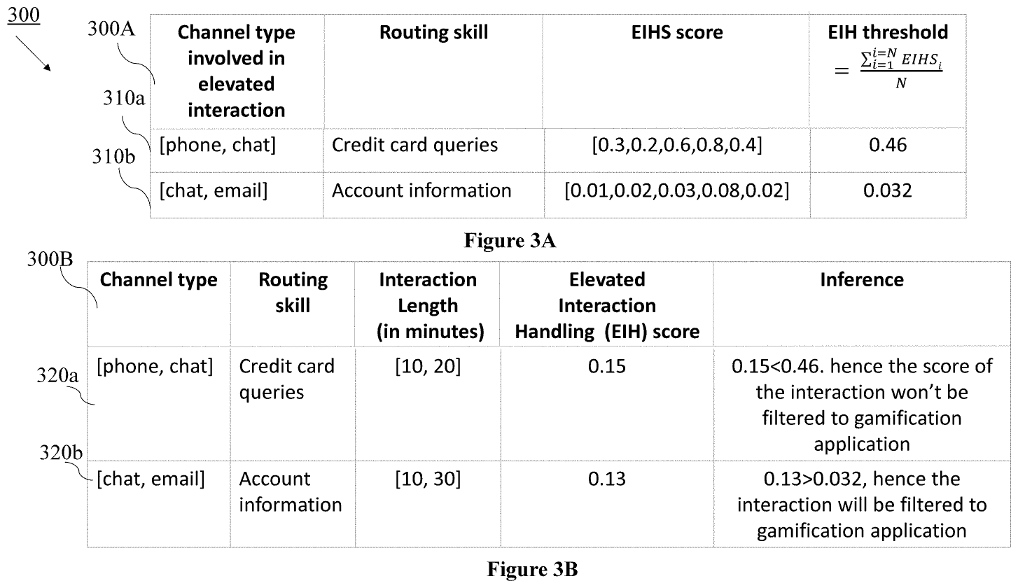

According to some embodiments of the present disclosure, the calculated EIH threshold may correspond to interaction characteristics to ensure consideration of the complexity of each interaction. The interaction characteristics may be selected from at least one of: routing skills for each interaction and the channel types involved in an elevated interaction, as shown in detail in FIGS. 3A-3B.

According to some embodiments of the present disclosure, the calculated EIH threshold may be based on formula III:

$$EIH threshold = \frac{{\sum }_{i = 1}^{i = N} EIHSi}{N} \qquad ( III )$$

whereby:
EIHSi is an Elevated Interaction Handling Score (EIHS) for a given interaction, and
N is total interactions for a given one or more routing skills and channel type.

FIG. 1B schematically illustrates a high-level diagram of a computerized-system 100B for identifying and utilizing effectiveness of an agent elevating channels during an interaction, in an Omnichannel Session Handling (OSH) environment, in accordance with some embodiments of the present disclosure.

According to some embodiments of the present disclosure, computerized-system 100B may include the same elements as computerized-system 100A in FIG. 1A, as described in detail above. The elements may be a processor 105, which may operate an interaction module 120 to retrieve interactions of an agent, from a data storage of interactions 130, according to a time range and forward it to a module, such as EIE module 110, and such as EIE 200 in FIGS. 2A-28, which may calculate an EIH score, as described above. The agents may be retrieved from a data storage of agents 145.

According to some embodiments of the present disclosure, a module, such as data generator module (not shown) may collect information related to the filtered interactions from various data sources and stored in a data storage, such as data storage of elevated interactions 135, which may be further be utilized by EIE module 110.

According to some embodiments of the present disclosure, the module, such as EIE module 110 and such as EIE 200 in FIGS. 2A-2B, may send the EIH score to the one or more applications 150a-150c to take one or more follow-up actions based on the EIH score, when the EIH score may be above or below a calculated EIH threshold.

According to some embodiments of the present disclosure, the one or more applications 150 of computerized-system 100A, in FIG. 1A, may be an application, such as a gamification solution, e.g., gamification application 150a, a quality management application, e.g., Quality Management (QM) application 150b or Automatic Call Distribution (ACD) system 150c or any combination thereof.

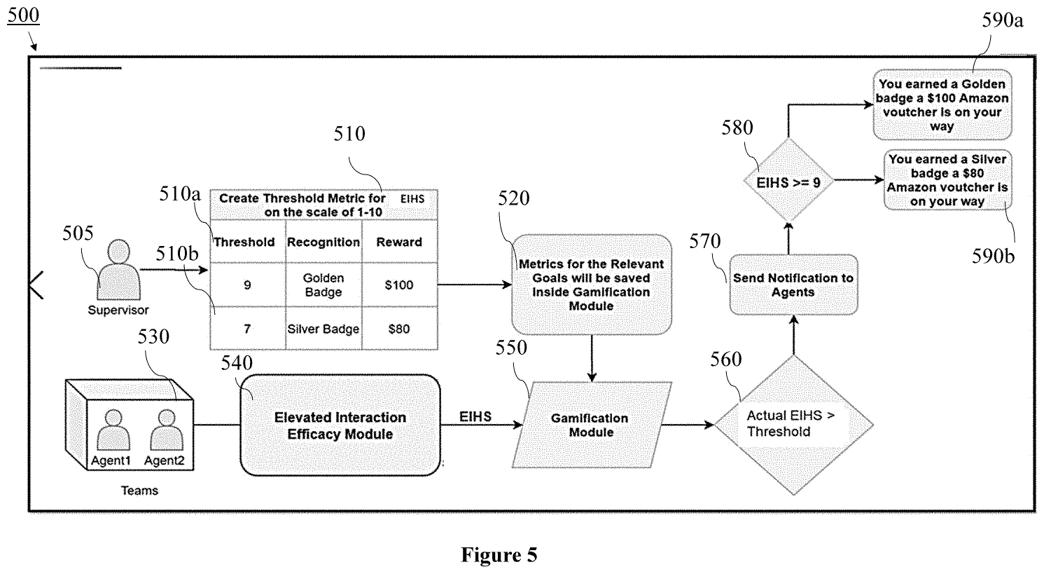

According to some embodiments of the present disclosure, when one application of the one or more applications 150 in FIG. 1A is a gamification solution, e.g., gamification application 150a, the one or more follow-up actions of the gamification application, based on the calculated EIH score, may be defining organization goals and metric 160a and providing at least one reward or recognition to the agent 160b. The at least one reward or recognition to the agent may be provided to the agent when the EIH score may be above a predefined threshold 140a or between a predefined range, as shown in detail below, and in example 500, in FIG. 5.

According to some embodiments of the present disclosure, the organization goals and metric 160a may be goals and metrics of an agent that a company or an organization define as a success factor, which have an impact on the growth of the company in the long run. The highest EIH score of all agents may define one metric for the organization which will be applicable to agents engaged in elevating channels during an interaction, in an Omnichannel Session Handling (OSH) environment, at the same session.

According to some embodiments of the disclosure, another application may be an application which provides Quality Management (QM) solutions. QM solutions are commonly used in contact centers to evaluate the performance of the agents and for the assignment of relevant training or coaching programs, upon one or more indications. It may be beneficial for a contact center to provide a QM solution, such as QM application 150b, a score that may indicate the efficiency and the effectiveness of agent elevating an interaction, at the same session, to promote a high level of this proficiency in agents in the contact center.

According to some embodiments of the present disclosure, the one or more follow-up actions of QM solutions, such as QM application 150b, based on the calculated EIH score, may be initiating an evaluation and coaching program 160c to the agent by an evaluator. When the calculated EIH score may be below the calculated EIH threshold 140b, the agent may be assigned by an evaluator to a coaching program.

According to some embodiments of the disclosure, systems in contact centers that should be updated with agents' proficiency and expertise level, as it may change over time. For example, an Automatic Call Distribution (ACD) system, such as ACD system 150c, which has the capability to route omnichannel interactions to agents having the required proficiency, with the adequate expertise level, at the right time. For example, if the agent can handle elevated interactions effectively and efficiently i.e., high EIH score, then the attributes of the routing skills of the agent can be changed from beginner to expert or when the EIH score is poor the routing skills of the agent may be changed from expert to beginner.

According to some embodiments of the present disclosure, a score such as EIH may be calculated by a module EIE module 110 and such as EIE 200 in FIGS. 2A-2B, every duty cycle e.g., 3 hours, which is a time range that may be preconfigured. For each time range, for each agent elevated interactions may be filtered out from the retrieved one or more interactions of an agent.

According to some embodiments of the present disclosure, the computerized-system, such as computerized-system 100B may be operating in a cloud computing environment. Therefore, before the processor 105 is operating the EIE module 110, the processor 105 may be operating a module to select a tenant from a data storage of tenants (not shown) to operate the EIE module 110 for each agent in a data storage of agents of the selected tenant.

FIGS. 2A-2B are a high-level workflow of Elevated Interaction Efficacy (EIE) module, in accordance with some embodiments of the present disclosure.

According to some embodiments of the present disclosure, operation 210 may comprise operating an interaction module to retrieve one or more interactions of the agent from the data storage of interactions, according to a time range. The interaction module may be a module, such as interaction module 120 in FIG. 1A. The data storage of interactions may be a data storage, such as data storage of interactions 130 in FIG. 1A.

According to some embodiments of the present disclosure, operation 220 may comprise filtering out from the retrieved interactions, one or more elevated interactions, to be stored in the data storage of elevated interactions, based on one or more attributes from metadata of the retrieved interactions. The data storage of elevated interactions may be a data storage such as data storage of elevated interactions 135 in FIG. 1A.

According to some embodiments of the present disclosure, operation 230 may comprise calculating an Elevated Interaction Handling (EIH) score for the agent based on one or more attributes from the metadata of the one or more elevated interactions to provide an indication as to an ability of the agent to elevate channels during an interaction, at the same session.

According to some embodiments of the present disclosure, operation 240 may comprise storing the calculated EIH score in the data storage of agents. The data storage of agents may be a data storage, such as data storage of agents 145 in FIG. 1A.

According to some embodiments of the present disclosure, operation 250 may comprise sending the EIH score to the one or more applications, to take one or more follow-up actions based on the EIH score, when the EIH score is above or below a calculated EIH threshold. The one or more applications may be one or more applications such as one or more applications 150 in FIG. 1A.

FIG. 3A is illustrating an example 300A of calculating an Elevated Interaction Handling (EIH) threshold based on historical interactions data, in accordance with some embodiments of the present disclosure.

According to some embodiments of the present disclosure, EIH threshold may be calculated based on data of historic interactions. The calculated EIH threshold is corresponding to interaction characteristics to ensure consideration of interaction complexity. The interaction characteristics may be selected from at least one of: routing skills for an interaction and channel types involved in an elevated interaction.

According to some embodiments of the present disclosure, the EIH threshold may be calculated based on formula III:

$$EIH threshold = \frac{{\sum }_{i = 1}^{i = N} EIHSi}{N} \qquad ( III )$$

whereby:
EIHSi is Elevated Interaction Handling Score for a give interaction, and
N is total interactions for a given one or more routing skills and channel type.

According to some embodiments of the present disclosure, the EIH threshold may be calculated per each routing skill and per each channel type that has been involved in an elevated interaction. In example 310a, for channel type involved in each elevated interaction from phone call to chat, for a routing skill of credit card queries, there may be five results of EIH score for five interactions (0.3, 0.2, 0.6, 0.8, 0.4) during a predefined time range. Accordingly, the calculated EIH threshold may be based on formula III in example 310a as follows: (0.3+0.2+0.6+0.8+0.4)/5=0.46.

According to some embodiments of the present disclosure, in example 310b, for the channel types involved in each elevated interaction from chat to email for a routing skill of account information there may be five results of EIH score for five interactions (0.01, 0.02, 0.03, 0.08, 0.02) during a predefined time range. Accordingly, the EIH threshold may be based on formula III in example 310b as follows: (0.01+0.02+0.03+0.08+0.02)/5=0.032.

FIG. 3B is illustrating an example 300B of filtering upcoming interactions for other applications, based on EIH threshold, in accordance with some embodiments of the present disclosure.

According to some embodiments of the present disclosure, for an elevated interaction from a phone call to a chat 320a where a routing skill of credit card queries has been required, and where the phone call duration has been 10 minutes and the chat duration has been 20 minutes a module, such as an Elevated Interaction Efficacy (EIE) module 110 in FIG. 1A and such as EIE module in FIGS. 2A-2B may calculate an EIH Score (EIHS) based on formula I:

$$EIHS = CS * ( \frac{1}{T 1} + \frac{1}{T 2} + … \frac{1}{Tn} ) * Weffective \qquad ( I )$$

whereby:
CS is Customer Sentiment (CS) score for a given elevated interaction,
Tn is time spent on channel-n,
Weffective is an effective weighting factor of multiple channels request based on formula II:

Πᵢ₌₁^{N}Wi (II)

whereby:
Wi equals T/D
whereby:
T is a total interaction volume occurred for a channel type in a previous duty cycle,
D is a duty cycle time range, which has been configured for EIE module to run.

According to some embodiments of the present disclosure, formula I which is the formula for deriving the EIH score the agent, may be directly proportional to the customer sentiment score and effective weightage of the complete interaction and inversely proportional to the time taken in each elevated channel within the session. The effective weightage may be an indication of total interaction volume occurred in the previous duty cycle of the EIE module.

According to some embodiments of the present disclosure, the calculated EIHS in example 320a is 0.15 and the calculated EIH threshold for the channel types involved and routing skill is 0.46, as shown in example 310a in FIG. 3A. Therefore, since 0.15<0.46, the interaction will not be filtered to a gamification application but may be filtered to QM application for training and coaching purposes.

According to some embodiments of the present disclosure, the calculated EIHS, in example 320b is 0.13 and the calculated EIH threshold for the channel types involved and routing skill is 0.032, as shown in example 310b in FIG. 3A. Therefore, since 0.13<0.032, the interaction will be filtered to a gamification application for reward and recognition purposes to the agent, as shown in example 500 in FIG. 5.

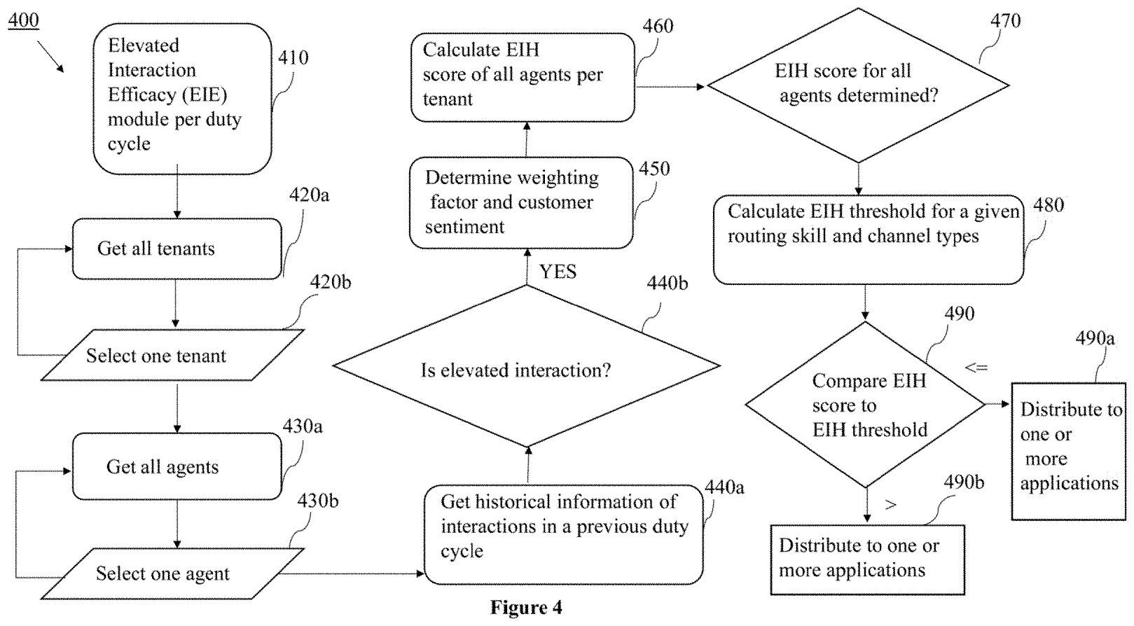

FIG. 4 is a high-level workflow 400 of calculating an EIH score for agents of one or more tenants in a cloud computing environment, in accordance with some embodiments of the present disclosure.

According to some embodiments of the present disclosure, a duty cycle is a time period in which a module runs periodically.

According to some embodiments of the present disclosure, when a computerized system, such as computerized system 100A in FIG. 1A is operating in a cloud computing environment, before operating the EIE module 410, such as EIE module 110 in FIG. 1A, a computerized-method may operate, every predefined duty cycle, a module to get all tenants 420a in the cloud computing environment and then may select a tenant 420b from a data storage of tenants (not shown) to operate the EIE module 410, such as EIE module 110 in FIG. 1A, for each agent in the data storage of agents of the selected tenant.

According to some embodiments of the present disclosure, the EIE module 410, such as EIE module 110 in FIG. 1A, may get all agents 430a and then select one agent 430b.

According to some embodiments of the present disclosure, for the selected agent, EIE module 410 may get historical information of recorded interactions in a previous duty cycle 440a. Then, the EIE module may check if the interaction is an elevated interaction 440b.

According to some embodiments of the present disclosure, if it is an elevated interaction, the EIE module 410 may determine a weighting factor and customer sentiments 450. The weighting factor expresses the load of each channel type during a duty cycle. The weighting factor may be an effective weighting factor of multiple channels request based on formula II:

Πᵢ₌₁^{N}Wi (II)

whereby:
Wi equals T/D
whereby:
T is a total interaction volume occurred for a channel type in a previous duty cycle,
D is a duty cycle time range, which has been configured for EIE module to run.

According to some embodiments of the present disclosure, the weight factor may be changed based on total interaction volume which has arrived in the contact center on a given channel during the duty cycle.

According to some embodiments of the present disclosure, the EIE module 410 may calculate an EIH Score, for each agent of all agents, per tenant 460. Then, the EE module 410 may check if EIH score for all agents has been determined 470.

According to some embodiments of the present disclosure, the EIE module 410 may calculate EIH threshold for a given routing skill and channel types 480, as shown in examples 310a and 310b in FIG. 3A.

According to some embodiments of the present disclosure, the EIE module 410 may compare for each agent the EIH score to the EIH threshold and accordingly if the EIH score is below the EIH threshold, the EIE module 410 may distribute to one or more applications 490a, e.g. a QM application. If the EIH score is above the EIH threshold, the EE module 410 may distribute to one or more applications 490b, such as gamification application for reward and recognition purposes, as described above.

According to some embodiments of the present disclosure, for the ACD system, it may depend on the value of the EIH score. For example, the level of the agent may be changed from beginner to expert when the EIH score is high or from expert to beginner when the EIH score is poor, e.g. below the threshold.

FIG. 5 schematically illustrates components of an example 500 of a computerized system for identifying and utilizing effectiveness of an agent elevating channels during an interaction, in accordance with some embodiments of the present disclosure.

Gamification solutions are commonly used to motivate agents and to improve their performance and rank by providing challenges, activities, quests, campaigns and tasks. These levels and activities are designed to boost the agents' performance by allowing them to “level-up”. For any gamification project to succeed, an organization needs to align the goals of agents with those of the business itself.

According to some embodiments of the present disclosure, a user, such as a supervisor 405, may predefine an Elevated Interaction Handling (EIH) threshold and may set goals. The metrics for the goals may be saved in a gamification module 520. Based on a calculated EIH score, which may be calculated by a module, such as EIE module 110 in FIGS. 1A-1B, some rewards and recognition may be provided to agents 530.

For example, a preconfigured threshold may be an EIH score above ‘9’ as in element 510a, which may assign the agent a recognition of golden badge and a reward of $100. The threshold may be an EIH score between a predefined range, such as 7⇐MMES<9 as shown in element 410b, which may assign the agent with a silver badge and a reward of $80. Such a metric 510 may be created and saved inside the gamification application and may set goals to be saved in a gamification module.

According to some embodiments of the present disclosure, in a team such as team 530 for each agent an EIH score may be calculated for elevated interaction handling in a predefined range of time by an EIE module 540, such as EIE module 110 in FIGS. 1A-1B. The calculated EIH score may be sent to a gamification module 550, which has already been provided with a metric of EIH threshold recognition and reward, such as metric 510.

According to some embodiments of the present disclosure, the calculated EIH score of each agent in the team 530, may be compared with the threshold in a predefined metric, such as metric 510, e.g., actual EIH score>= threshold EIH threshold 560. When the calculated EIH score of one or more agents complies with the conditions in metric 510, then the gaming application may take a follow-up action such as send a notification to agents 570.

According to some embodiments of the present disclosure, for example, when the calculated EIH score of an agent may be above ‘9’, according to metric 510, the agent may receive a notification “you earned a golden badge a $100 Amazon voucher is on your way” 590a.

According to some embodiments of the present disclosure, in another example, when the calculated EIH score of an agent may be between the range of ‘7’ and ‘9’, e.g., ‘7’⇐EIH score<‘9’, according to metric 510, the agent may receive a notification “you earned a silver badge a $80 Amazon voucher is on your way” 590b.

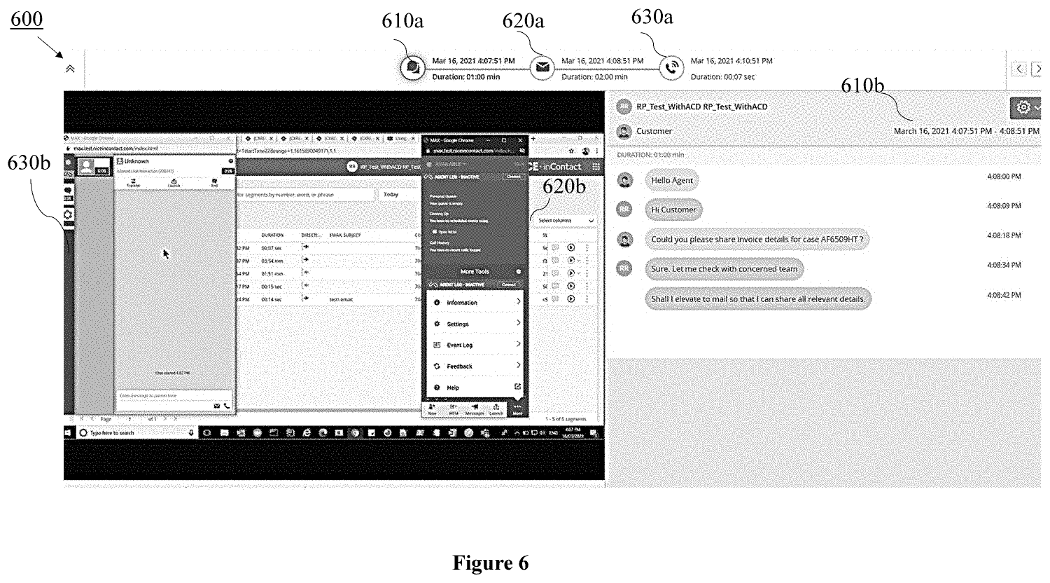

FIG. 6 is illustrating an example 600 of a playback of an elevated interaction between an agent and a customer in three different channels, in accordance with some embodiments of the present disclosure.

According to some embodiments of the present disclosure, an interaction between an agent and a customer may commence via a chat channel 610a and 610b on Mar. 16, 2021 at 4:07.51 P M and for a duration of 01:00 minute till 4:08:51 and then the interaction may be elevated to an email channel 620a and 620b, for the purpose of sharing of details. The duration of the email channel may be 02:00 minutes, from 4:08:51 to 4:10:51. Then, to better clarify the issue, the interaction may be elevated, right after, to a phone call at 4:10:51 P M for a duration of 00:07 seconds.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for identifying and utilizing effectiveness of an agent elevating channels during an interaction, in an Omnichannel Session Handling (OSH) environment, said computerized-method comprising:
in a computerized system comprising a processor, one or more applications, a data storage of interactions, a data storage of elevated interactions, and a data storage of agents and a memory to store the data storages, said processor is configured to operate, during a duty cycle, an Elevated Interaction Efficacy (EIE) module for each agent in the data storage of agents, said operating of said EIE module comprising:
(a) operating an interaction module to retrieve one or more interactions of the agent from the data storage of interactions, according to a time range;
(b) filtering out from the retrieved interactions, one or more elevated interactions, to be stored in the data storage of elevated interactions, based on one or more attributes from metadata of the retrieved interactions;
(c) calculating an Elevated Interaction Handling (EIH) score for the agent based on one or more attributes from the metadata of the one or more elevated interactions to provide an indication as to an ability of the agent to elevate channels during an interaction at the same session;
(d) storing the calculated EIH score in the data storage of agents; and
(e) sending the EIH score to the one or more applications, to take one or more follow-up actions based on the EIH score and a calculated EIH threshold.

2. The computerized-method of claim 1, wherein one application of the one or more applications is a gamification application.

3. The computerized-method of claim 2, wherein the one or more follow-up actions of the gamification application based on the EIH score, is providing at least one reward or recognition to the agent.

4. The computerized-method of claim 3, wherein the at least one reward or recognition to the agent is provided to the agent when the EIH score is above a predefined threshold or between a predefined range.

5. The computerized-method of claim 1, wherein one application of the one or more applications is a Quality Management (QM) application.

6. The computerized-method of claim 5, wherein the one or more follow-up actions of the QM application based on the EIH score is assigning a coaching program by an evaluator.

7. The computerized-method of claim 1, wherein one application of the one or more applications is an Automated Call Distribution (ACD) system.

8. The computerized-method of claim 7, wherein the one or more follow-up actions of the ACD system based on the EIH score includes changing attributes of routing skills of the agent.

9. The computerized-method of claim 1, wherein the metadata of the one or more elevated interactions includes a customer sentiment score.

10. The computerized-method of claim 9, wherein the calculating of the EIH Score (EIHS) is based on formula I:
$$EIHS = CS * ( \frac{1}{T 1} + \frac{1}{T 2} + … \frac{1}{Tn} ) * Weffective \qquad ( IV )$$
whereby:
CS is Customer Sentiment (CS) score for a given elevated customer,
Tn is time spent on channel-n,
Weffective is an effective weighting factor of multiple channels request based on formula II:
Πᵢ₌₁^{N}Wi (V)
whereby:
Wi equals T/D
whereby:
T is a total interaction volume occurred for a channel type in a previous duty cycle,
D is a duty cycle time range, which has been configured for EIE module to run.

11. The computerized-method of claim 1, wherein the calculated EIH threshold is corresponding to interaction characteristics to ensure consideration of interaction complexity.

12. The computerized-method of claim 11, wherein interaction characteristics are selected from at least one of: routing skills for an interaction, channel types involved in an elevated interaction.

13. The computerized-method of claim 1, wherein the calculated EIH threshold is based on formula III:
$$EIH threshold = \frac{{\sum }_{i = 1}^{i = N} EIHSi}{N} \qquad ( VI )$$
whereby:
EIHSi is Elevated Interaction Handling Score for a give interaction, and
N is total interactions for a given one or more routing skills and channel type.

14. The computerized-method of claim 1, wherein when the computerized-method is operating in a cloud computing environment, before operating the EIE module the computerized-method is further comprising selecting a tenant from a data storage of tenants to operate the EIE module for each agent in the data storage of agents of the selected tenant.

15. The computerized-method of claim 1, wherein the one or more attributes from metadata of the retrieved interactions are selected from at least one of: InteractionId, Interaction duration, customerRating, OpenReasonType and interactionStartTime.

16. The computerized-method of claim 15, wherein the filtering out from the retrieved interactions, one or more elevated interactions, to be stored in the data storage of elevated interactions is based on the OpenReasonType attribute.

17. A computerized-system for identifying and utilizing effectiveness of an agent elevating channels during an interaction, in an Omnichannel Session Handling (OSH) environment, the computerized-system comprising:
a processor;
one or more applications;
a data storage of interactions;
a data storage of elevated interactions
a data storage of agents; and
a memory to store the data storages,
said processor is operating a Multiple Multi-Channel Effectiveness (EIE) module for each agent in a data storage of agents, said EIE module is configured to:
(a) operate an interaction module to retrieve one or more interactions of an agent from the data storage of interactions, according to a time range;
(b) filter out from the retrieved interactions, one or more elevated interactions, to be stored in the data storage of elevated interactions, based on one or more attributes from metadata of the retrieved interactions;
(c) calculate an Elevated Interaction Handling (EIH) score for the agent based on one or more attributes from the metadata of the one or more elevated interactions to provide an indication as to an ability of the agent to elevate channels during an interaction at the same session;
(d) store the calculated EIH score in the data storage of agents; and
(e) send the EIH score to the one or more applications, to take one or more follow-up actions based on the EIH score and a calculated EIH threshold.
